(19) United States
(12) Patent Application Publication
(10) Pub. No.: US 2021/0311700 A1
(43) Pub. Date: Oct. 7, 2021

(54) DUAL-SCREEN ELECTRONIC DEVICE AND SETTING METHOD FOR OUTPUT SETTINGS OF AUDIO SIGNAL

(71) Applicant: Wistron Corp., New Taipei City (TW)

(72) Inventor: Pao-Shun CHANG, New Taipei City (TW)

(21) Appl. No.: 16/900,777

(22) Filed: Jun. 12, 2020

(30) Foreign Application Priority Data
Apr. 1, 2020 (TW) 109111145

(51) Int. Cl. G06F 3/16

(52) U.S. Cl. CPC G06F 3/167

(57) ABSTRACT

A dual-screen electronic device includes a first display device, a second display device, a plurality of sensors, a sensor controller, an embedded controller and an audio device. The sensors generate a plurality of sensing signals. The sensors include a first sensor and a second sensor, and the first sensor is configured in the first display device and the second sensor is configured in the second display device. The sensor controller obtains the sensing signals. The sensor controller generates display-mode information according to the sensing signals. The embedded controller obtains the display-mode information through a first transmission interface. The embedded controller generates setting information according to the display-mode information. The audio device obtains the setting information through a second transmission interface. The audio device sets the output settings of the audio signals of a plurality of audio-signal output channels according to the setting information.

### CROSS REFERENCE TO RELATED APPLICATIONS

This application claims priority of TW Patent Application No. 109111145 filed on Apr. 1, 2020, the entirety of which is incorporated by reference herein.

### BACKGROUND OF THE INVENTION

### Field of the Invention

The invention generally relates to technology for the output settings of audio signals, and more particularly, it relates to a dual-screen electronic device in which the hardware is directly used to set the output settings of the audio signals of the audio-signal output channel according to the display mode of the dual-screen electronic device.

### Description of the Related Art

Dual-screen electronic products (such as a dual-screen notebook) are proposed that employ recent advances made as a result of technological progress. For different display modes of the dual-screen notebook, the outputs of the audio signals of the dual-screen notebook may need different settings. That is, as the display mode of a dual-screen notebook is switched, the output settings of the audio signals of the audio-signal output channels need to be adjusted accordingly.

According to the design of current dual-screen notebooks, after the sensor hub of a dual-screen notebook reads the data sensed by the sensors to calculate the display mode of the dual-screen notebook, the sensor hub may indicate the sensor hub driver to notify the operating system. Then, the audio driver may read the display mode recoded by the operating system, and transmit the output settings of the audio signals to the audio device to play the accurate audio signals.

However, the above method needs to progress through a sensor hub driver, an operating system, and an audio driver. Therefore, a time delay may be generated when the audio signal is switched. Therefore, how to set the output settings of the audio signals of the audio-signal output channel more efficiently will be an important subject.

### BRIEF SUMMARY OF THE INVENTION

The embodiments of the invention provide dual-screen electronic devices and setting methods for the output settings of the audio signals to overcome the problems described above.

An embodiment of the invention provides a dual-screen electronic device. The dual-screen electronic device includes a first display device, a second display device, a plurality of sensors, a sensor controller, an embedded controller and an audio device. The sensors generate a plurality of sensing signals. The sensors include at least a first sensor and a second sensor, and the first sensor is configured in the first display device and the second sensor is configured in the second display device. The sensor controller is coupled to the sensors to obtain the sensing signals. The sensor controller generates display-mode information according to the sensing signals. The embedded controller is coupled to the sensor controller through a first transmission interface to obtain the display-mode information from the sensor controller. The embedded controller generates setting information according to the display-mode information. The audio device is coupled to the embedded controller through a second transmission interface to obtain the setting information from the embedded controller. The audio device sets the output settings of the audio signals of a plurality of audio-signal output channels according to the setting information.

In some embodiments, the first transmission interface is an I²C bus and the second transmission interface is a GPIO interface.

In some embodiments, the setting information indicates settings of a first pin and a second pin of the GPIO interface and the audio device sets the output settings of the audio signals of the audio-signal output channels according to the settings of the first pin and the second pin.

In some embodiments, the dual-screen electronic device further includes a plurality of audio-signal output devices. The audio-signal output devices are coupled to the audio device and play the audio signals according to the output settings of the audio signals of the audio-signal output channels.

In some embodiments, the audio device is coupled to the sensor controller through a third transmission interface to directly obtain the display-mode information from the sensor controller. The audio device sets the output settings of the audio signals of the audio-signal output channels according to the display-mode information, wherein the third transmission interface is an I²C bas.

An embodiment of the invention provides a setting method for the output settings of the audio signals. The setting method for the output settings of the audio signals is applied to a dual-screen electronic device. The setting method for the output settings of the audio signals includes the steps of generating, using a plurality of sensors of the dual-screen electronic device, a plurality of sensing signals, wherein the sensors include at least a first sensor and a second sensor, and the first sensor is configured in a first display device of the dual-screen electronic device and the second sensor is configured in a second display device of the dual-screen electronic device; obtaining, using a sensor controller of the dual-screen electronic device, the sensing signals, and generating display-mode information according to the sensing signals; obtaining, using an embedded controller of the dual-screen electronic device, the display-mode information from the sensor controller through a first transmission interface, and generating setting information according to the display-mode information; and obtaining, using an audio device of the dual-screen electronic device, the setting information from the embedded controller through a second transmission interface, and setting the output settings of audio signals of a plurality of audio-signal output channels according to the setting information.

Other aspects and features of the invention will become apparent to those with ordinary skill in the art upon review of the following descriptions of specific embodiments of the dual-screen electronic device and setting method for the output settings of the audio signals.

### BRIEF DESCRIPTION OF THE DRAWINGS

The invention will become more fully understood by referring to the following detailed description with reference to the accompanying drawings, wherein:

FIG. 1 is a block diagram of a dual-screen electronic device 100 according to an embodiment of the invention;

FIG. 2A is a schematic diagram of a laptop mode of a dual-screen electronic device 100 according to an embodiment of the invention;

FIG. 2B is a schematic diagram of a book mode of a dual-screen electronic device 100 according to an embodiment of the invention;

FIG. 2C is a schematic diagram of a book mode of a dual-screen electronic device 100 according to another embodiment of the invention;

FIG. 2D is a schematic diagram of a tablet mode of a dual-screen electronic device 100 according to an embodiment of the invention; and

FIG. 3 is a flow chart illustrating a setting method for the output settings of the audio signals according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

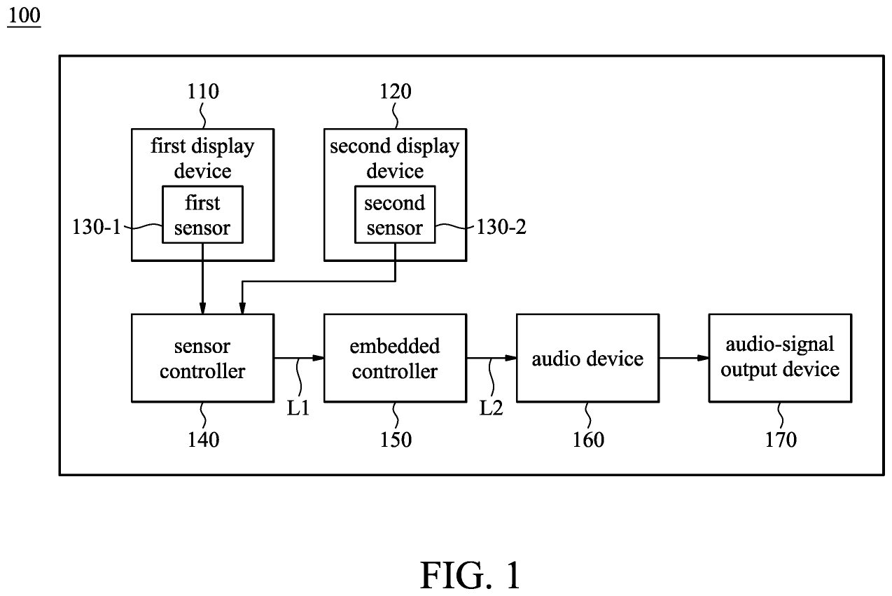

FIG. 1 is a block diagram of a dual-screen electronic device 100 according to an embodiment of the invention. According to an embodiment of the invention, the electronic device with dual-screen may be a notebook with dual-screen. As shown in FIG. 1, the dual-screen electronic device 100 may include at least a first display device 110, a second display device 120, a plurality of sensors 130 (in FIG. 1, the first sensor 130-1 and the second sensor 130-2 are present, but the invention should not be limited thereto), a sensor controller 140, an embedded controller (EC) 150, an audio device 160 and a plurality of audio-signal output devices 170. It should be noted that in order to clarify the concept of the invention, FIG. 1 presents a simplified block diagram in which only the elements relevant to the invention are shown. However, the invention should not be limited to what is shown in FIG. 1. The dual-screen electronic device 100 may include other elements.

In an embodiment of the invention, the first display device 110 may be a display panel or screen of the dual-screen electronic device 100. The second display device 120 may be the other display panel or screen of the dual-screen electronic device 100.

In an embodiment of the invention, a plurality of sensors 130 may be configured in the first display device 110 and the second display device 120 to sense the position information (e.g. orientation and rotation angle) of the first display device 110 and the second display device 120 to generate a plurality of sensing signals. In addition, the sensors 130 may transmit the sensing signals to the sensor controller 140. According to an embodiment of the invention, the sensors 130 may include at least the first sensor 130-1 and the second sensor 130-2. The first sensor 130-1 is configured in the first display device 110, and the second sensor 130-2 is configured in the second display device 120. It should be noted that other sensors also can be configured in the first display device 110 and the second display device 120. The first sensor 130-1 and the second sensor 130-2 are used to illustrate the embodiments of the invention, but the invention should be limited thereto. The first sensor 130-1 and the second sensor 130-2 may be Gravity-sensor (G-sensor), accelerometer or Gyro Meter, but the invention should not be limited thereto. According to an embodiment of the invention, the first sensor 130-1 may sense the rotation angle of the first display device 110 to generate the sensing signal corresponding to the first display device 110; and the second sensor 130-2 may sense the rotation angle of the second display device 120 to generate the sensing signal corresponding to the second display device 120.

In an embodiment of the invention, after the sensor controller 140 obtains the sensing signals from the sensors 130, the sensor controller 140 may determine the display mode of the dual-screen electronic device according to the sensing signals. Specifically, the sensor controller 140 may obtain the position information (e.g., orientation and rotation angle) of the first display device 110 and the second display device 120 according to the sensing signals. The sensor controller 140 may know the relative angle and relative position of the first display device 110 and the second display device 120 therebetween, according to the orientations and rotation angles of the first display device 110 and the second display device 120 to determine the display mode of the dual-screen electronic device 100. In an embodiment of the invention, the display modes of the dual-screen device may include a laptop mode, a book mode and a tablet mode, but the invention should not be limited thereto. The sensor controller 140 may generate display-mode information according to the current display mode of the dual-screen electronic device 100 and transmit the display-mode information to the embedded controller 150.

In an embodiment of the invention, the sensor controller 140 is coupled to the embedded controller 150 through a first transmission interface L1. The first transmission interface L1 may be an inter-integrated circuit bus (I²C bus), but the invention should not be limited thereto. The embedded controller 150 may obtain the display-mode information through the first transmission interface L1. Then, the embedded controller 150 may generate the setting information according to the display-mode information and transmit the setting information to the audio device 160.

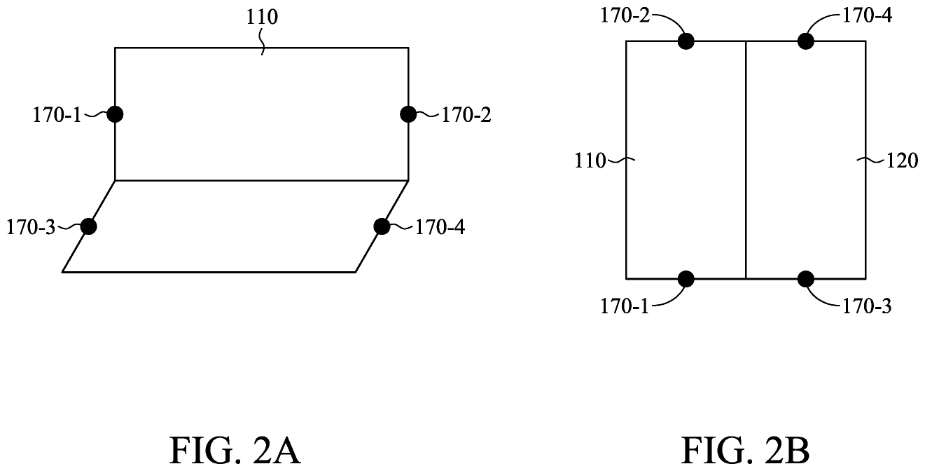

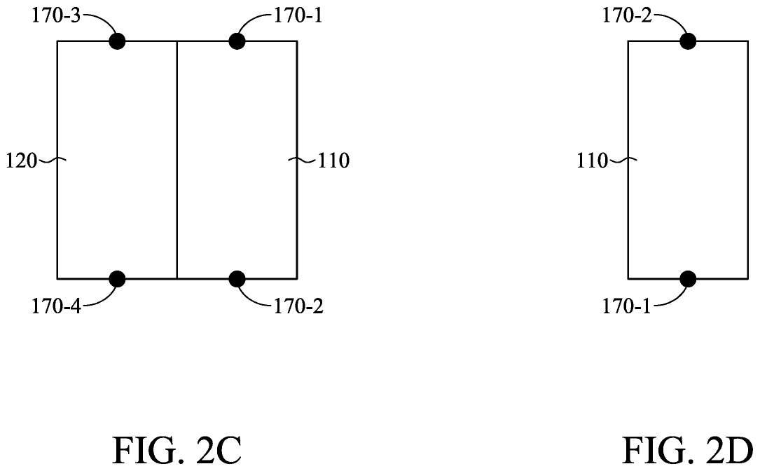

In an embodiment of the invention, the audio device 160 may be coupled to the embedded controller 150 through a second transmission interface L2 to obtain the setting information from the embedded controller 150. According to an embodiment of the invention, the second transmission interface L2 may be a General Purpose Input/Output (GPIO) interface, but the invention should not be limited thereto. The audio device 160 may obtain the display mode of the dual-screen electronic device 100 according to the setting information. According to an embodiment of the invention, if the second transmission interface L2 is a GPIO interface, the setting information may indicate the settings of a first pin and a second pin of the GPIO interface. The audio device 160 may obtain the display mode of the dual-screen electronic device 100 according to the settings of the first pin and the second pin of the GPIO interface to set the output settings of the audio signals of its audio-signal output channels. Table 1 is used to illustrate below, but the invention should not be limited thereto. According to an embodiment of the invention, the audio device 160 may have a plurality of audio-signal output channels to output a plurality of audio signals to the audio-signal output devices 170. Each audio-signal output channel may correspond to an audio-signal output device 170. After the audio device 160 knows the display mode of the dual-screen electronic device 100, the audio device 160 may output accurate audio signals to the audio-signal output device 170 through each audio-signal output channel to play the audio signals. FIG. 2A-2D and Table 1 are used as an example for illustration below, but the invention should not be limited thereto.

TABLE 1

| | | audio- | audio- | audio- | audio- |
|---|---|---|---|---|---|
| Settings | | signal | signal | signal | signal |
| of first | | output | output | output | output |
| pin/second | Display | channel | channel | channel | channel |
| pin | mode | C1 | C2 | C3 | C4 |
| 0/0 | laptop | left | right | left | right |
| | mode | channel | channel | channel | channel |
| 0/1 | first | left | left | right | right |
| | book | channel | channel | channel | channel |
| | mode | | | | |
| 1/0 | second | right | right | left | left |
| | book | channel | channel | channel | channel |
| | mode | | | | |
| 1/1 | tablet | Mono | Mono | Mono | Mono |
| | mode | | | | |

Table 1 shows the output settings of the audio-signal output channels which the audio device 160 setting according to the settings of the first pin and the second pin. As shown in Table 1, the audio device 160 have the audio-signal output channel C1, audio-signal output channel C2, audio-signal output channel C3 and audio-signal output channel C4, but the invention should not be limited thereto. The audio device 160 may know the display mode of the dual-screen electronic device 100 according to the setting information (i.e. the settings of the first pin and the second pin of the GPIO interface (second transmission interface L2)). Then, the audio device 160 may set the output settings of the audio signals of the audio-signal output channel C1, audio-signal output channel C2, audio-signal output channel C3 and audio-signal output channel C4.

FIG. 2A is a schematic diagram of a laptop mode of a dual-screen electronic device 100 according to an embodiment of the invention. FIG. 2B is a schematic diagram of a book mode of a dual-screen electronic device 100 according to an embodiment of the invention. FIG. 2C is a schematic diagram of a book mode of a dual-screen electronic device 100 according to another embodiment of the invention. FIG. 2D is a schematic diagram of a tablet mode of a dual-screen electronic device 100 according to an embodiment of the invention.

Referring to Table 1, the embodiments of FIG. 2A-2D are assumed that the audio-signal output device 170-1 and the audio-signal output device 170-2 configured in the first display device 110 correspond to the audio-signal output channel C1 and the audio-signal output channel C2 respectively; and the audio-signal output device 170-3 and the audio-signal output device 170-4 configured in the second display device 120 correspond to the audio-signal output channel C3 and the audio-signal output channel C4 respectively.

As shown in FIG. 2A, in response to the audio device 160 knowing the display mode of the dual-screen electronic device 100 is laptop mode, the audio device 160 may output the left-channel audio signals to the audio-signal output device 170-1 configured in the first display device 110 and the audio-signal output device 170-3 configured in the second display device 120 through the audio-signal output channel C1 and the audio-signal output channel C3 respectively. In addition, the audio device 160 may output the right-channel audio signals to the audio-signal output device 170-2 configured in the first display device 110 and the audio-signal output device 170-4 configured in the second display device 120 through the audio-signal output channel C2 and the audio-signal output channel C4 respectively.

As shown in FIG. 2B, in response to the audio device 160 knowing the display mode of the dual-screen electronic device 100 is the first book mode, the audio device 160 may output the left-channel audio signals to the audio-signal output device 170-1 and the audio-signal output device 170-2 configured in the first display device 110 through the audio-signal output channel C1 and the audio-signal output channel C2 respectively. In addition, the audio device 160 may output the right-channel audio signals to the audio-signal output device 170-3 and the audio-signal output device 170-4 configured in the second display device 120 through the audio-signal output channel C3 and the audio-signal output channel C4 respectively.

As shown in FIG. 2C, in response to the audio device 160 knowing the display mode of the dual-screen electronic device 100 is the second book mode, the audio device 160 may output the right-channel audio signals to the audio-signal output device 170-1 and the audio-signal output device 170-2 configured in the first display device 110 through the audio-signal output channel C1 and the audio-signal output channel C2 respectively. In addition, the audio device 160 may output the left-channel audio signals to the audio-signal output device 170-3 and the audio-signal output device 170-4 configured in the second display device 120 through the audio-signal output channel C3 and the audio-signal output channel C4 respectively.

As shown in FIG. 2D, in response to the audio device 160 knowing the display mode of the dual-screen electronic device 100 is the tablet mode, the audio device 160 may output the mono audio signals to the audio-signal output device 170-1, the audio-signal output device 170-2, the audio-signal output device 170-3 and the audio-signal output device 170-4 through the audio-signal output channel C1, the audio-signal output channel C2, the audio-signal output channel C3 and the audio-signal output channel C4 respectively. It should be noted that because in the tablet mode, the first display device 110 overlaps with the second display device 120, FIG. 2D merely presents the audio-signal output device 170-1 and the audio-signal output device 170-2.

According to an embodiment of the invention, if the dual-screen electronic device 100 only have the audio-signal output device 170-1 and the audio-signal output device 170-2 (i.e., the audio-signal output devices only configured in the first display device 110), in response to the audio device 160 knowing the display mode of the dual-screen electronic device 100 is the laptop mode, the audio device 160 may output the left-channel audio signal to the audio-signal output device 170-1 configured in the first display device 110 through the audio-signal output channel C1 and output the right-channel audio signal to the audio-signal output device 170-2 configured in the first display device 110 through the audio-signal output channel C2. In response to the audio device 160 knowing the display mode of the dual-screen electronic device 100 is the book mode, the audio device 160 may output the mono audio signal to the audio-signal output device 170-1 and the audio-signal output device 170-2 through the audio-signal output channel C1 and the audio-signal output channel C2 respectively. In response to the audio device 160 knowing the display mode of the dual-screen electronic device 100 is the tablet mode, the audio device 160 may output the mono audio signal to the audio-signal output device 170-1 and the audio-signal output device 170-2 through the audio-signal output channel C1 and the audio-signal output channel C2 respectively. The embodiment is only used to illustrate one method for there are only two audio-signal output devices configured in the dual-screen electronic device 100, but the invention should not be limited thereto.

According to an embodiment of the invention, the audio device 160 may be directly coupled to the sensor controller 140 through a third transmission interface. According to an embodiment of the invention, the third transmission interface may be an I²C bus. In the embodiment, the audio device 160 may obtain the display information from the sensor controller 140 directly and set the output settings of the audio signals of the audio-signal output channels according to the display information. That is, the audio device does not need to obtain the display mode of the dual-screen electronic device 100 through the embedded controller 150.

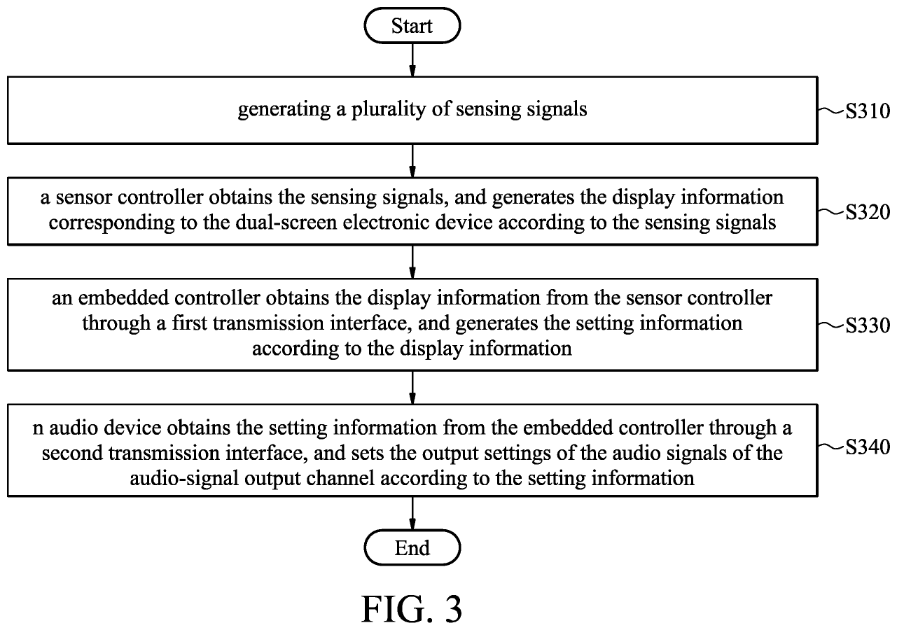

FIG. 3 is a flow chart illustrating a setting method for the output settings of the audio signals according to an embodiment of the invention. The setting method for the output settings of the audio signals can be applied to the dual-screen electronic device 100. As shown in FIG. 3, in step S310, a plurality of sensors of the dual-screen electronic device 100 generate a plurality of sensing signals, wherein the sensors include at least a first sensor and a second sensor. The first sensor is configured in the first display device of the dual-screen electronic device 100 and the second sensor is configured in the second display device of the dual-screen electronic device 100.

In step S320, a sensor controller of the dual-screen electronic device 100 obtains the sensing signals and generates the display information corresponding to the dual-screen electronic device 100 according to the sensing signals.

In step S330, an embedded controller of the dual-screen electronic device 100 obtains the display information from the sensor controller through a first transmission interface and generates the setting information according to the display information.

In step S340, an audio device of the dual-screen electronic device 100 obtains the setting information from the embedded controller through a second transmission interface, and it then sets the output settings of the audio signals of the audio-signal output channel according to the setting information.

In some embodiments of the invention, the first transmission interface may be an fc bus and the second transmission interface may be a GPIO interface. In some embodiments of the invention, the setting information indicates the settings of the first pin and the second pin of the GPIO interface. The audio device of the dual-screen electronic device 100 sets the output settings of the audio signals of the audio-signal output channels according to the settings of the first pin and the second pin.

In an embodiment of the invention, a plurality of audio-signal output devices of the dual-screen electronic device 100 play the audio signals according to the output settings of the audio signals of the audio-signal output channels.

In an embodiment of the invention, the audio device of the dual-screen electronic device 100 obtains the display-mode information from the sensor controller through a transmission interface and according to the display-mode information, the audio device of the dual-screen electronic device 100 sets the output settings of the audio signals of the audio-signal output channels, wherein the third transmission interface is a I²C bas.

According to the setting method for the output settings of the audio signals, the dual-screen electronic device 100 will not set the output settings of the audio signals of the audio-signal output channels through the sensor hub driver, operating system, and audio driver. The dual-screen electronic device 100 can directly set the output settings of the audio signals of the audio-signal output channels according to its hardware. Therefore, according to the setting method for the output settings of the audio signals, it will be more efficient for setting the output settings of the audio signals of the audio-signal output channels. In addition, the complexity of setting the output settings of the audio signals of the audio-signal output channels will be reduced.

Use of ordinal terms such as “first”, “second”, “third”, etc., in the disclosure and claims is for description. It does not by itself connote any order or relationship.

The steps of the method described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such that the processor can read information (e.g., code) from and write information to the storage medium. A sample storage medium may be integral to the processor. The processor and the storage medium may reside in an ASIC. The ASIC may reside in user equipment. Alternatively, the processor and the storage medium may reside as discrete components in user equipment. Moreover, in some aspects any suitable computer-program product may include a computer-readable medium comprising codes relating to one or more of the aspects of the disclosure. In some aspects a computer program product may include packaging materials.

The above paragraphs describe many aspects. Obviously, the teaching of the invention can be accomplished by many methods, and any specific configurations or functions in the disclosed embodiments only present a representative condition. Those who are skilled in this technology will understand that all of the disclosed aspects in the invention can be applied independently or be incorporated.

While the invention has been described by way of example and in terms of preferred embodiment, it should be understood that the invention is not limited thereto. Those who are skilled in this technology can still make various alterations and modifications without departing from the scope and spirit of this invention. Therefore, the scope of the present invention shall be defined and protected by the following claims and their equivalents.

1. A dual-screen electronic device, comprising:
a first display device;
a second display device;
a plurality of sensors, generating a plurality of sensing signals, wherein the plurality of sensors comprise at least a first sensor and a second sensor, and the first sensor is configured in the first display device and the second sensor is configured in the second display device;
a sensor controller, coupled to the plurality of sensors to obtain the plurality of sensing signals, and generating display-mode information according to the plurality of sensing signals;
an embedded controller, coupled to the sensor controller through a first transmission interface to obtain the display-mode information from the sensor controller, and generating setting information according to the display-mode information; and
an audio device, coupled to the embedded controller through a second transmission interface to obtain the setting information from the embedded controller, and setting output settings of audio signals of a plurality of audio-signal output channels according to the setting information.

2. The dual-screen electronic device of claim 1, wherein the first transmission interface is an I²C bus and the second transmission interface is a GPIO interface.

3. The dual-screen electronic device of claim 2, wherein the setting information indicates settings of a first pin and a second pin of the GPIO interface and the audio device sets the output settings of the audio signals of the audio-signal output channels according to the settings of the first pin and the second pin.

4. The dual-screen electronic device of claim 1, further comprising:
a plurality of audio-signal output devices, coupled to the audio device and playing the audio signals according to the output settings of the audio signals of the audio-signal output channels.

5. The dual-screen electronic device of claim 1, wherein the audio device is coupled to the sensor controller through a third transmission interface to directly obtain the display-mode information from the sensor controller and sets the output settings of the audio signals of the audio-signal output channels according to the display-mode information, wherein the third transmission interface is an I²C bus.

6. A setting method for the output settings of the audio signals, applied to a dual-screen electronic device, comprising:
generating, by a plurality of sensors of the dual-screen electronic device, a plurality of sensing signals, wherein the plurality of sensors comprise at least a first sensor and a second sensor, and the first sensor is configured in a first display device of the dual-screen electronic device and the second sensor is configured in a second display device of the dual-screen electronic device;
obtaining, by a sensor controller of the dual-screen electronic device, the plurality of sensing signals, and generating display-mode information according to the plurality of sensing signals;
obtaining, by an embedded controller of the dual-screen electronic device, the display-mode information from the sensor controller through a first transmission interface, and generating setting information according to the display-mode information; and
obtaining, by an audio device of the dual-screen electronic device, the setting information from the embedded controller through a second transmission interface, and setting output settings of audio signals of a plurality of audio-signal output channels according to the setting information.

7. The setting method for the output settings of the audio signals of claim 6, wherein the first transmission interface is an I²C bus and the second transmission interface is a GPIO interface.

8. The setting method for the output settings of the audio signals of claim 7, wherein the setting information indicates settings of a first pin and a second pin of the GPIO interface and the audio device sets the output settings of the audio signals of the audio-signal output channels according to the settings of the first pin and the second pin.

9. The setting method for the output settings of the audio signals of claim 6, further comprising:
playing, by a plurality of audio-signal output devices of the dual-screen electronic device, the audio signals according to the output settings of the audio signals of the audio-signal output channels.

10. The setting method for the output settings of the audio signals of claim 6, further comprising:
directly obtaining, by the audio device of the dual screen electronic device, the display-mode information from the sensor controller through a third transmission interface; and
setting the output settings of the audio signals of the audio-signal output channels according to the display-mode information, wherein the third transmission interface is an I²C bus.
